(19) United States
(12) Patent Application Publication
(10) Pub. No.: US 2025/0013802 A1
(43) Pub. Date: Jan. 9, 2025

(54) NETWORK-COUPLED MODELING METHOD FOR FIRE SPREAD OF LITHIUM-ION BATTERY ENERGY STORAGE SYSTEM

(71) Applicant: China University of Petroleum (East China), Qingdao (CN)

(72) Inventors: Depeng KONG, Qingdao (CN); Gongquan WANG, Qingdao (CN); Ping PING, Qingdao (CN)

(73) Assignee: China University of Petroleum (East China), Qingdao (CN)

(21) Appl. No.: 18/361,882

(22) Filed: Jul. 30, 2023

(30) Foreign Application Priority Data
Jul. 7, 2023 (CN) 2023108288177

(51) Int. Cl. G06F 30/20; G01R 31/367

(52) U.S. Cl. CPC G06F 30/20; G01R 31/367

(57) ABSTRACT

The present disclosure provides a coupling network model lithium-ion battery energy storage system fire spread modeling method, which belongs to the technical field of lithium-ion battery model construction and simulation method. The coupling network model lithium-ion battery energy storage system fire spread modeling method includes: obtaining battery electrochemical parameters, material thermophysical parameters and energy storage system geometric characteristic parameters of a battery energy storage system; establishing a three-dimensional geometric model of air domain inside the energy storage system and performing a grid division; calculating the heat generated inside batteries during thermal runaway; solving the heat transfer and the thermal runaway propagation process between batteries, and calculating the battery temperatures; calculating the gas generation inside batteries during thermal runaway; solving jet dynamics parameters of batteries; and, solving the conservation equations of fluid regions in the battery energy storage system, to predict the fire spread behavior inside an energy storage power station.

### CROSS-REFERENCE TO RELATED APPLICATIONS

The application claims priority to Chinese patent application No. 2023108288177, filed on Jul. 7, 2023, the entire contents of which are incorporated herein by reference.

### TECHNICAL FIELD

The present disclosure belongs to the technical field of lithium-ion battery model construction and simulation methods, and relates specifically to a network-coupled modeling method for fire spread of lithium-ion battery energy storage system.

### BACKGROUND

With the acceleration of electrification progress in China, the energy storage industry in China has developed rapidly, and there is also an ever-increasing application demand for rechargeable batteries. Due to the advantages of high energy density, low self-discharge rate, long service life, green environmental protection and the like, lithium-ion batteries have been widely used in fields such as electric vehicles and energy storage systems. However, due to the large amount of active materials and electrical energy involved, the safety issue caused by thermal runaway is still an obstacle to the large-scale application of lithium-ion batteries. In addition to releasing a large amount of heat during the thermal runaway process, lithium-ion batteries will also generate a large amount of combustible gases such as hydrogen, carbon monoxide, and alkanes inside thereof, which will cause the increase in pressure inside batteries and exhaust. Jet fires occur when exhausted combustible gases are ignited directly by an ignition source or when the temperature reaches their ignition points. In a lithium-ion battery module, the heat released by batteries can easily heat adjacent batteries, causing thermal runaway of the adjacent batteries, and in turn causing all the batteries in the module to fail. Meanwhile, the failed battery modules in the energy storage power station will heat up other modules, which will trigger a chain reaction, eventually causing large-scale fire and explosion accidents. Therefore, the research on the thermal runaway and fire spread behavior inside the energy storage power station is of great significance to the safety design of lithium-ion battery modules and energy storage systems, as well as the formulation of emergency response measures for accidents.

However, thermal runaway and fire tests at the scale of energy storage power stations face huge time and economic costs. Compared with experimental research methods, numerical simulation methods are not limited by time, space and parameter measurement strategies, can comprehensively predict the temperature evolution, fire spread characteristics and combustion heat release characteristics of batteries in the fire spread process, and are powerful tools for studying the hazards of lithium-ion battery accidents and assisting in the safety design of battery energy storage systems. The current simulation models for thermal runaway propagation and fire spread of lithium-ion batteries mostly focus on the single battery level and the battery module level, but rarely involve the larger-scale battery cluster level and system level simulations, so it is difficult to calculate the thermal runaway propagation behavior of lithium-ion batteries at the energy storage system level and to simulate the fire evolution inside energy storage systems after an accident occurs.

### SUMMARY

In view of this, the present disclosure provides a coupling network model lithium-ion battery energy storage system fire spread modeling method, which can calculate the thermal runaway propagation behavior of lithium-ion batteries at the energy storage system level, and at the same time can simulate the fire evolution inside the energy storage system after an accident occurs.

The present disclosure is achieved in a way as follows:
the present disclosure provides a coupling network model lithium-ion battery energy storage system fire spread modeling method, which includes the following steps:
S10: obtaining battery electrochemical parameters, material thermophysical parameters and energy storage system geometric characteristic parameters of a battery energy storage system;
S20: establishing a three-dimensional geometric model of air domain inside the energy storage system and performing a grid division, according to the battery electrochemical parameters, the material thermophysical parameters and the energy storage system geometric characteristic parameters;
S30: establishing a thermal runaway model of a single battery node in the battery energy storage system, to calculate the heat generated inside batteries during thermal runaway;
S40: establishing a thermal resistance network model of a battery region in the battery energy storage system, to solve the heat transfer and thermal runaway propagation process between batteries, and calculate the battery temperatures;
S50: establishing a gas generation model of a single battery node in the battery energy storage system, to calculate the gas generation inside batteries during thermal runaway;
S60: establishing a mass flow model of a battery region in the battery energy storage system, to solve jet dynamics parameters of batteries; and
S70: solving a conservation equation of a fluid region in the battery energy storage system, with the battery temperatures and the jet dynamics parameters of the batteries as boundary conditions, to predict the fire spread behavior inside an energy storage power station.

Based on the above technical solution, a coupling network model lithium-ion battery energy storage system fire spread modeling method of the present disclosure can also be improved as follows:
wherein the step of establishing a thermal runaway model of a single battery node in the battery energy storage system specifically includes:
step 1, the lumped transient energy conservation equation based on the Arrhenius formula, describing the process in which the battery temperature continues to rise due to the heat released by the electrochemical reaction during thermal runaway;

$${m}_{c} {C}_{p , c} \frac{dT}{dt} = {Q}_{TR} + \sum \frac{{T}_{neigh} - T}{R} ; \\ {Q}_{TR} = - {\sum }_{i} Δ {H}_{i} \frac{{dc}_{i}}{dt} ;$$

where, m_{c} is the mass of a battery, p is the density, C_{p,c} is the specific heat capacity of a battery, T is the node temperature, T_{neigh} is the temperature of an adjacent node, t is the time, Q_{TR} is the heat released by the side reaction in the thermal runaway process, ΔHᵢ is the enthalpy value of a thermal abuse reaction, cᵢ is the dimensionless concentration of an active material, dcᵢ/dₜ can be solved by using the Arrhenius formula, and R is a constant; and
step 2, determining the control equation of the thermal runaway model, which specifically includes:
SEI film decomposition:

$$\frac{{dc}_{SEI}}{dt} = - {A}_{SEI} {c}_{SEI} exp ( - \frac{{Ea}_{SEI}}{RT} ) ;$$

negative electrode reaction:

$$\frac{{dc}_{a}}{dt} = - {A}_{a} {c}_{a} exp ( - \frac{{Ea}_{a}}{RT} ) exp ( - \frac{{c}_{SEI}}{{c}_{SEI , ref}} ) ;$$

positive electrode reaction:

$$\frac{d {α}_{c}}{dt} = {A}_{c} {α}_{c} ( 1 - {α}_{c} ) exp ( - \frac{{Ea}_{c}}{RT} ) ;$$

electrolyte decomposition:

$$\frac{{dc}_{e}}{dt} = - {A}_{e} {c}_{e} exp ( - \frac{{Ea}_{e}}{RT} ) ;$$

binder reaction:

$$\frac{{dc}_{PVDF}}{dt} = - {A}_{PVDF} {c}_{PVDF} exp ( - \frac{{Ea}_{PVDF}}{RT} ) .$$

Further, the step of establishing a thermal resistance network model of a battery region in the battery energy storage system includes:
based on the consideration of the heat conduction between batteries, the heat convection between a battery and the top fluid (flame) of a battery package, and the heat exchange between a battery and the surrounding environment, determining the energy balance of a single battery node in the thermal resistance network as:

$${m}_{c} {C}_{p , c} \frac{{dT}_{c , x , y , z}}{dt} = {Q}_{TR} + {\sum }_{i = x - 1 , x + 1} \frac{{T}_{c , i , y , z} - {T}_{c , x , y , z}}{{R}_{κ , x}} + {\sum }_{j = y - 1 , y + 1} \frac{{T}_{c , x , j , z} - {T}_{c , x , y , z}}{{R}_{κ , y}} + ( \frac{{T}_{v , xm , z - 1} - {T}_{c , x , y , z}}{{R}_{h , u}} + \frac{{T}_{v , xm , z} - {T}_{c , x , y , z}}{{R}_{h , l} + {R}_{s}} ) ;$$

where, the subscript c represents a battery, the subscript v represents the fluid at the top of a battery, and, x, y and z represent the position coordinates of a battery in the battery cluster; R_{k,x} represents the thermal conduction resistance between batteries along the x direction, and R_{k,y} represents the thermal conduction resistance between batteries along the y direction; R_{h,u} represents the thermal convection resistance at the top of a battery module, and R_{h,l} represents the thermal convection resistance at the bottom of a battery module; and, R_{S} represents the thermal resistance of the battery pack casing;
determining the fluid region at the top of a battery module as a separate node, wherein in the entire thermal runaway propagation process, batteries continue to exchange heat with the top high-temperature fluid through convective heat exchange, the high-temperature gas and flame injected by batteries increase the temperature of the top fluid, so the energy conservation equation of the fluid node at the top of the battery module is determined as:

$${m}_{v} {C}_{p , v} \frac{{dT}_{v , xm , z}}{dt} - {\sum }_{i ∈ {M}_{xm}} {\sum }_{j = 1}^{{n}_{y}} {\dot{m}}_{c , i , j , z} {C}_{p , v} {T}_{f} + {\dot{m}}_{v , xm , z} {C}_{p , v} {T}_{v , xm , z} = {\sum }_{i ∈ {M}_{xm}} {\sum }_{j = 1}^{{n}_{y}} \frac{{T}_{c , i , j , z} - {T}_{v , xm , z}}{{R}_{h , u}} + {\sum }_{i ∈ {M}_{xm}} {\sum }_{j = 1}^{{n}_{y}} \frac{{T}_{c , i , j , z + 1} - {T}_{v , xm , z}}{{R}_{h , l} + {R}_{s}} ;$$

where, the subscript xm represents the position coordinate of the battery package inside the energy storage power station, \dot{m}c represents the mass flow rate when exhaust occurs in the battery, and T_{f} represents the temperature of the discharged gas; and
obtaining the temperature evolution of each battery node by coupling solution of the above equations, to calculate the fluid mechanics model.

Further, the step of establishing a gas generation model of a single battery node in the battery energy storage system includes:
the gas generation process inside a lithium-ion battery including electrolyte evaporation and side reaction release, wherein the evaporation rate in the electrolyte evaporation process is:

$${\dot{n}}_{e} = {α}_{l} {l}_{1} {l}_{2} \frac{2 C}{2 - C} \sqrt{\frac{{M}_{e}}{2 π R}} \frac{{ρ}_{v} {Δ}_{vap} H ( T - {T}_{sat} )}{{T}_{sat}^{3 / 2} {M}_{e}} ;$$

where, αₗ is the volume fraction of the electrolyte in a coil core, l₁ and l₂ are the geometric parameters of a battery, C is the evaporation coefficient; Mₑ is the molar mass of the electrolyte, ρᵥ is the vapor density inside a battery, ΔᵥₐₚH is the enthalpy of evaporation, and Tₛₐₜ is the saturation temperature of the electrolyte, expressed as:

$${T}_{sat} = \frac{1413}{6.4338 - log ( P / 1000 )} + 44.25 ;$$

where, P represents the pressure inside a battery.

Further, for the reaction gases, hydrogen, carbon monoxide, carbon dioxide, methane, ethylene, and ethane are mainly considered, and their generation rates are considered to be a linear function of the electrochemical reaction rate,

$${\dot{n}}_{g} = \sum {ω}_{i} \frac{{dc}_{i}}{dt} ;$$

where, ωᵢ is the gas generation coefficient, obtained from the experimentally measured total amount of gas generation.

Further, the step of establishing a mass flow model of a battery region in the battery energy storage system specifically includes: the internal pressure and the jet dynamics model of a fluid node in the battery module are calculated by using ordinary differential equations, where, the control equation representing the pressure change is expressed as:

$$\frac{{dn}_{v , xm , z}}{dt} = {\sum }_{i ∈ {M}_{xm}} {\sum }_{j = 1}^{{n}_{y}} ( {\dot{n}}_{e , i , j , z} + {\dot{n}}_{g , i , j , z} ) - \frac{φ {C}_{d} {A}_{v} {ρ}_{v , xm , z} {u}_{v , xm , z}}{{M}_{v , xm , z}} ;$$

where, the first term on the right represents the molar flow rate when exhaust occurs in the battery, and the second term represents the gas loss due to the exhaust of the battery pack. Where, φ is the blockage coefficient, C_{d} is the exhaust coefficient, Aᵥ is the area of the exhaust valve of the battery package, ρ is the gas density, and u is the gas jet velocity.

Further, the jet velocity is calculated from the internal pressure of a battery, expressed as:

$${P}_{v} = max ( {P}_{a} , {( \frac{2}{γ + 1} )}^{γ / ( γ - 1 )} P ) ;$$

$$Ma = min ( 1 , \sqrt{( {( \frac{P}{{P}_{v}} )}^{( γ - 1 ) / γ} - 1 ) \frac{2}{γ - 1}} ) ;$$

$$u = Ma \sqrt{\frac{γ {P}_{v}}{ρ}} ;$$

where, γ represents the heat capacity ratio of the discharged gas mixture, Pᵥ is the pressure at the exhaust valve of the battery package, and P_{α} is the environmental pressure; Mα is the Mach number.

Further, the step of solving jet dynamics parameters of a battery specifically includes: analyzing and calculating the mass flow model of a battery region in the battery energy storage system by using the Reynolds time-averaged Navier-Stokes equation, where, a single-equation k-ε model is used as the turbulence model, and the control equations for different physical parameters in the model are respectively:

### Mass:

$$\frac{\partial \overline{ρ}}{\partial t} + \frac{\partial {\overline{ρ u}}_{j}}{\partial {x}_{j}} = 0 ;$$

### Momentum:

$$\frac{\partial {\overline{ρ u}}_{j}}{\partial t} + \frac{\partial {\overline{ρ u}}_{i} {\overline{u}}_{j}}{\partial {x}_{j}} = \frac{\partial }{\partial {x}_{j}} ( ρ ( v + {v}_{t} ) ( \frac{\partial {\overline{u}}_{i}}{\partial {x}_{j}} + \frac{\partial {\overline{u}}_{j}}{\partial {x}_{i}} - \frac{2}{3} \frac{\partial {\overline{u}}_{k}}{\partial {x}_{k}} {δ}_{ij} ) ) - \frac{\partial {\overline{p}}_{d}}{\partial {x}_{i}} - {g}_{i} {x}_{i} \frac{\partial \overline{p}}{\partial {x}_{i}} ;$$

### Energy:

$$\frac{\partial \overline{ρ h}}{\partial t} + \frac{\partial {\overline{ρ u}}_{j} \overline{h}}{\partial {x}_{j}} = \frac{D \overline{p}}{Dt} + \frac{\partial }{\partial {x}_{j}} [ \overline{ρ} ( D + \frac{{v}_{t}}{{Pr}_{t}} ) \frac{\partial \overline{h}}{\partial {x}_{j}} ] ;$$

### Component:

$$\frac{\partial {\overline{ρ Y}}_{m}}{\partial t} + \frac{\partial {\overline{ρ u}}_{j} {\overline{Y}}_{m}}{\partial {x}_{j}} = \frac{\partial }{\partial {x}_{j}} [ \overline{ρ} ( D + \frac{{v}_{t}}{{Pr}_{t}} ) \frac{\partial {\overline{Y}}_{m}}{\partial {x}_{j}} ] ;$$

### Turbulent Kinetic Energy:

$$\frac{\partial k}{\partial t} + {\overline{u}}_{j} \frac{\partial k}{\partial {x}_{j}} = \frac{\partial }{\partial {x}_{j}} [ \frac{( v + {v}_{t} )}{{σ}_{k}} \frac{\partial k}{\partial {x}_{j}} ] - ε + {τ}_{ij} \frac{\partial {\overline{u}}_{i}}{\partial {x}_{j}} ;$$

### Dissipation Rating:

$$\frac{\partial ε}{\partial t} + {\overline{u}}_{j} \frac{\partial ε}{\partial {x}_{j}} = \frac{\partial }{\partial {x}_{j}} [ \frac{( v + {v}_{t} )}{{σ}_{k}} \frac{\partial ε}{\partial {x}_{j}} ] + {C}_{ε 1} \frac{ε}{k} {τ}_{ij} \frac{\partial {\overline{u}}_{i}}{\partial {x}_{j}} - {C}_{ε 2} \frac{{ε}^{2}}{k} .$$

Further, the step of calculating the heat generated inside a battery during thermal runaway specifically includes:
solving the combustion behavior inside the battery energy storage system by the eddy dissipation concept (EDC) model, wherein the combustion rate of each gas component is considered to be a function of the fluid temperature and the reaction gas concentration, expressed as:

$$ω = A \cdot exp {{{( - Ea / RT ) [ Fue1 ]}^{a} [ {O}_{2} ]}^{b} [ {H}_{2} O ]}^{c} ;$$

where, [Fuel], [O₂] and [H₂O] respectively represent the proportions of fuel, oxygen and water in a grid; and, a, b and c are the reaction orders.

Further, the step of solving a conservation equation of a fluid region in the battery energy storage system, to predict the fire spread behavior inside the energy storage power station, specifically includes:
with the battery temperatures and the jet dynamics parameters of the batteries as the boundary conditions, the heat generation inside the batteries during the thermal runaway and the gas generation inside the battery during the thermal runaway are introduced into OpenFOAM for coupling to solve the conservation equation of the fluid region in the battery energy storage system, thereby predicting the fire spread behavior inside the energy storage power station.

Compared with the prior art, a coupling network model lithium-ion battery energy storage system fire spread modeling method provided in the present disclosure has the following beneficial effects: the present disclosure makes up for the research shortcoming that the existing lithium-ion battery thermal runaway propagation models fail to cover large-scale spaces such as energy storage systems, by the following way: obtaining battery electrochemical parameters, material thermophysical parameters and energy storage system geometric characteristic parameters of a battery energy storage system; establishing a three-dimensional geometric model of air domain inside the energy storage system and performing a grid division, according to the battery electrochemical parameters, the material thermophysical parameters and the energy storage system geometric characteristic parameters; establishing a thermal runaway model of a single battery node in the battery energy storage system, to calculate the heat generated inside the battery during thermal runaway; establishing a thermal resistance network model of a battery region in the battery energy storage system, to solve the heat transfer and thermal runaway propagation process between batteries, and calculate the battery temperature; establishing a gas generation model of a single battery node in the battery energy storage system, to calculate the gas generation inside the battery during thermal runaway; establishing a mass flow model of a battery region in the battery energy storage system, to solve jet dynamics parameters of the battery; and, solving the conservation equation of a fluid region in the battery energy storage system, with the battery temperatures and the jet dynamics parameters of the batteries as boundary conditions, to predict the fire spread behavior inside an energy storage power station; the models proposed in the present disclosure take into account the interaction between thermal runaway propagation and flame propagation, to realize a more accurate simulation of battery fault propagation behavior; this modeling method studies the characteristics and laws of the thermal runaway propagation behavior of lithium-ion batteries under different working conditions by changing a series of parameters, and can simulate the spatial distribution of temperatures inside and outside batteries, thereby providing a basis for the safety design of the energy storage system; this modeling method provides a model framework for lithium-ion battery model developers and simulation researchers, and can provide a basis and guidance for subsequent model development.

### BRIEF DESCRIPTION OF DRAWINGS

In order to provide a clearer explanation of technical solutions in the embodiments of the present disclosure, the accompanying drawings required for the description of the embodiments of the present disclosure will be briefly introduced below. Obviously, the accompanying drawings in the following description are only some embodiments of the present disclosure, and those skilled in the art can obtain other accompanying drawings according to these accompanying drawings without any creative labor made.

FIG. 1 is an operation flowchart of a coupling network model lithium-ion battery energy storage system fire spread modeling method.

FIG. 2 is a coupling process and calculation process of a thermal runaway propagation modeling method in the present disclosure.

FIG. 3 is a schematic diagram of a model geometry and grids in an embodiment of the present disclosure.

FIG. 4A, FIG. 4B, FIG. 4C and FIG. 4D are the comparison between the experimentally measured battery surface temperatures and the simulated battery temperatures in an embodiment of the present disclosure.

FIG. 5 is a simulated thermal runaway propagation evolution process of lithium-ion batteries in an energy storage power station in an embodiment of the present disclosure.

FIG. 6 is a simulated fire spread evolution process of lithium-ion batteries in an energy storage power station in an embodiment of the present disclosure.

FIG. 7 is heat release rate curves and total heat release curves during the simulated fire spread evolution process of lithium-ion batteries in an embodiment of the present disclosure.

### DETAILED DESCRIPTION OF THE EMBODIMENTS

For purposes, technical solutions and advantages of embodiments in the present disclosure to be clearer, the technical solutions in the embodiments of the present disclosure will be clearly and completely described below in combination with the accompanying drawings in the embodiments of the present disclosure. Obviously, the described embodiments are some but not all of the embodiments of the present disclosure. All other embodiments obtained by those skilled in the art without creative labor made, based on the embodiments of the present disclosure, should fall within the protection scope of the present disclosure. Accordingly, the following detailed description of the embodiments of the present disclosure provided in the accompanying drawings is not intended to limit the claimed scope of the present disclosure, but merely represents the selected embodiments of the present disclosure. All other embodiments obtained by those skilled in the art without creative labor made, based on the embodiments of the present disclosure, should fall within the protection scope of the present disclosure.

It should be noted that like numerals and letters denote similar items in the following accompanying drawings, therefore, once an item is defined in one figure, its further definition and explanation will not be required in subsequent accompanying drawings.

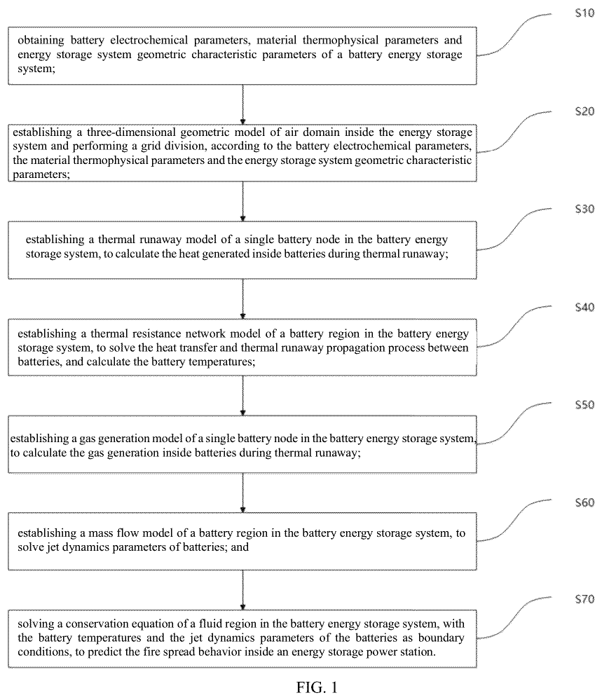

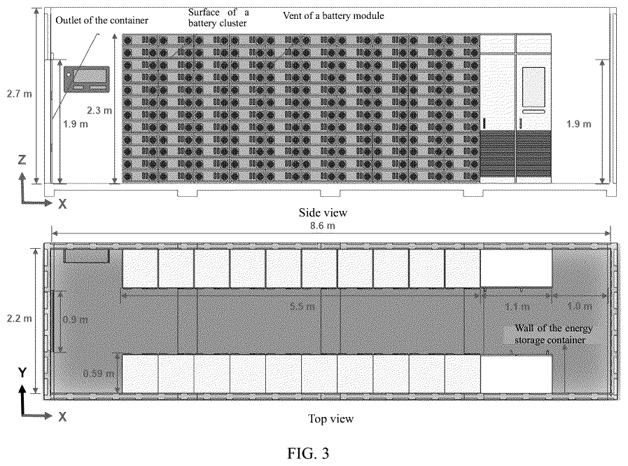

As shown in FIGS. 1-3, structural schematic diagrams of a coupling network model lithium-ion battery energy storage system fire spread modeling method provided in the present disclosure are shown. In the figures, the method includes the following steps:
S10: obtaining battery electrochemical parameters, material thermophysical parameters and energy storage system geometric characteristic parameters of a battery energy storage system;
S20: establishing a three-dimensional geometric model of air domain inside the energy storage system and performing a grid division, according to the battery electrochemical parameters, the material thermophysical parameters and the energy storage system geometric characteristic parameters;
S30: establishing a thermal runaway model of a single battery node in the battery energy storage system, to calculate the heat generated inside batteries during thermal runaway;
S40: establishing a thermal resistance network model of a battery region in the battery energy storage system, to solve the heat transfer and thermal runaway propagation process between batteries, and calculate the battery temperatures;
S50: establishing a gas generation model of a single battery node in the battery energy storage system, to calculate the gas generation inside batteries during thermal runaway;
S60: establishing a mass flow model of a battery region in the battery energy storage system, to solve jet dynamics parameters of batteries; and
S70: solving a conservation equation of a fluid region in the battery energy storage system, with the battery temperatures and the jet dynamics parameters of the batteries as boundary conditions, to predict the fire spread behavior inside an energy storage power station.

Wherein in the above technical solution, the step of establishing a thermal runaway model of a single battery node in the battery energy storage system specifically includes:
step 1, the lumped transient energy conservation equation based on the Arrhenius formula, describing the process in which the battery temperature continues to rise due to the heat released by the electrochemical reaction during thermal runaway;

$${m}_{c} {C}_{p , c} \frac{dT}{dt} = {Q}_{TR} + \sum \frac{{T}_{neigh} - T}{R} ;$$

$${Q}_{TR} = - {\sum }_{i} Δ {H}_{i} \frac{{dc}_{i}}{dt} ;$$

where, ρ is the density, Cₚ is the specific heat capacity, T is the node temperature, T_{neigh} is the temperature of an adjacent node, t is the time, Q_{TR} is the heat released by the side reaction in the thermal runaway process, ΔHᵢ is the enthalpy value of a thermal abuse reaction, cᵢ is the dimensionless concentration of the active material, dcᵢ/dₜ can be solved by using the Arrhenius formula, and R is a constant; and
step 2, determining the control equation of the thermal runaway model, which specifically includes:

### SEI Film Decomposition:

$$\frac{{dc}_{SEI}}{dt} = - {A}_{SEI} {c}_{SEI} exp ( - \frac{{Ea}_{SEI}}{RT} ) ;$$

### Negative Electrode Reaction:

$$\frac{{dc}_{a}}{dt} = - {A}_{a} {c}_{a} exp ( - \frac{{Ea}_{a}}{RT} ) exp ( - \frac{{c}_{SEI}}{{c}_{SEI , ref}} ) ;$$

### Positive Electrode Reaction:

$$\frac{d {α}_{c}}{dt} = {A}_{c} {α}_{c} ( 1 - {α}_{c} ) exp ( - \frac{{Ea}_{c}}{RT} ) ;$$

### Electrolyte Decomposition:

$$\frac{{dc}_{e}}{dt} = - {A}_{e} {c}_{e} exp ( - \frac{{Ea}_{e}}{RT} ) ;$$

### Binder Reaction:

$$\frac{{dc}_{PVDF}}{dt} = - {A}_{PVDF} {c}_{PVDF} exp ( - \frac{{Ea}_{PVDF}}{RT} ) .$$

Further, in the above technical solution, the step of establishing a thermal resistance network model of a battery region in the battery energy storage system includes:
based on the consideration of the heat conduction between batteries, the heat convection between a battery and the top fluid (flame) of a battery package, and the heat exchange between a battery and the surrounding environment, determining the energy balance of a single battery node in the thermal resistance network as:

$${m}_{c} {C}_{p , c} \frac{{dT}_{c , x , y , z}}{dt} = {Q}_{TR} + {\sum }_{i = x - 1 , x + 1} \frac{{T}_{c , i , y , z} - {T}_{c , x , y , z}}{{R}_{κ , x}} + {\sum }_{j = y - 1 , y + 1} \frac{{T}_{c , x , j , z} - {T}_{c , x , y , z}}{{R}_{κ , y}} + ( \frac{{T}_{v , xm , z - 1} - {T}_{c , x , y , z}}{{R}_{h , u}} + \frac{{T}_{v , xm , z} - {T}_{c , x , y , z}}{{R}_{h , l} + {R}_{s}} ) ;$$

where, the subscript c represents a battery, the subscript v represents the fluid at the top of a battery, and, x, y and z represent the position coordinates of a battery in the battery cluster; R_{k,x} represents the thermal conduction resistance between batteries along the x direction, and R_{k,y} represents the thermal conduction resistance between batteries along the y direction; R_{h,u} represents the thermal convection resistance at the top of a battery module, and R_{h,l} represents the thermal convection resistance at the bottom of a battery module; and, R_{S} represents the thermal resistance of the battery pack casing;
determining the fluid region at the top of a battery module as a separate node, wherein in the entire thermal runaway propagation process, batteries continue to exchange heat with the top high-temperature fluid through convective heat exchange, the high-temperature gas and flame injected by batteries increase the temperature of the top fluid, so the energy conservation equation of the fluid node at the top of the battery module is determined as:

$${m}_{ν} {C}_{p , ν} \frac{{dT}_{ν , xm , z}}{dt} - {\sum }_{i ∈ {M}_{xm}} {\sum }_{j = 1}^{{n}_{y}} {\dot{m}}_{c , i , j , z} {C}_{p , v} {T}_{f} + {\dot{m}}_{ν , xm , z} {C}_{p , v} {T}_{v , xm , z} = {\sum }_{i ∈ {M}_{xm}} {\sum }_{j = 1}^{{n}_{y}} \frac{{T}_{c , i , j , z} - {T}_{v , xm , z}}{{R}_{h , u}} + {\sum }_{i ∈ {M}_{xm}} {\sum }_{j = 1}^{{n}_{y}} \frac{{T}_{c , i , j , z + 1} - {T}_{v , xm , z}}{{R}_{h , l} + {R}_{s}} ;$$

where, the subscript xm represents the position coordinate of the battery package inside the energy storage power station, \dot{m}c represents the mass flow rate when exhaust occurs in the battery, and T_{f} represents the temperature of the discharged gas; and
obtaining the temperature evolution of each battery node by coupling solution of the above equations, to calculate the fluid mechanics model.

Further, in the above technical solution, the step of establishing a gas generation model of a single battery node in the battery energy storage system includes:
the gas generation process inside a lithium-ion battery including electrolyte evaporation and side reaction release, wherein the evaporation rate in the electrolyte evaporation process is:

$${\dot{n}}_{e} = {α}_{l} {l}_{1} {l}_{2} \frac{2 C}{2 - C} \sqrt{\frac{{M}_{e}}{2 π R}} \frac{{ρ}_{v} {Δ}_{vap} H ( T - {T}_{sat} )}{{T}_{sat}^{3 / 2} {M}_{e}} ;$$

where, αₗ is the volume fraction of the electrolyte in a coil core, l₁ and l₂ are the geometric parameters of a battery, C is the evaporation coefficient; Mₑ is the molar mass of the electrolyte, p_{ν} is the vapor density inside a battery, ΔᵥₐₚH is the enthalpy of evaporation, and Tₛₐₜ is the saturation temperature of the electrolyte, expressed as:

$${T}_{sat} = \frac{1413}{6.4338 - log ( P / 1000 )} + 44 \text{.25} ;$$

where, P represents the pressure inside a battery.

Further, in the above technical solution, for the reaction gases, hydrogen, carbon monoxide, carbon dioxide, methane, ethylene, and ethane are mainly considered, and their generation rates are considered to be a linear function of the electrochemical reaction rate,

$${\dot{n}}_{g} = \sum {ω}_{i} \frac{{dc}_{i}}{dt} ;$$

where, ωᵢ is the gas generation coefficient, obtained from the experimentally measured total amount of gas generation.

Further, in the above technical solution, the step of establishing a mass flow model of a battery region in the battery energy storage system specifically includes: the internal pressure and the jet dynamics model of a fluid node in the battery module are calculated by using ordinary differential equations, where, the control equation representing the pressure change is expressed as:

$$\frac{{dn}_{v , xm , z}}{dt} = {\sum }_{i ∈ {M}_{xm}} {\sum }_{j = 1}^{{n}_{y}} ( {\dot{n}}_{e , i , j , z} + {\dot{n}}_{g , i , j , z} ) - \frac{φ {C}_{d} {A}_{v} {ρ}_{v , xm , z} {u}_{v , xm , z}}{{M}_{v , xm , z}} ;$$

where, the first term on the right represents the molar flow rate when exhaust occurs in the battery, and the second term represents the gas loss due to the exhaust of the battery pack. Where, φ is the blockage coefficient, C_{d} is the exhaust coefficient, Aᵥ is the area of the exhaust valve of the battery package, ρ is the gas density, and u is the gas jet velocity.

Further, in the above technical solution, the jet velocity is calculated from the internal pressure of a battery, expressed as:

$${P}_{v} = max ( {P}_{a} , {( \frac{2}{γ + 1} )}^{γ / ( γ - 1 )} P ) ; \\ Ma = min ( 1 , \sqrt{( {( \frac{P}{{P}_{v}} )}^{( γ - 1 ) / γ} - 1 ) \frac{2}{γ - 1}} ) ; \\ u = Ma \sqrt{\frac{γ {P}_{v}}{ρ} ;}$$

where, γ represents the heat capacity ratio of the discharged gas mixture, Pᵥ is the pressure at the exhaust valve of the battery package, and P_{α} is the environmental pressure; Mα is the Mach number.

Further, in the above technical solution, the step of solving jet dynamics parameters of a battery specifically includes: analyzing and calculating the mass flow model of a battery region in the battery energy storage system by using the Reynolds time-averaged Navier-Stokes equation, where, a single-equation k-ε model is used as the turbulence model, and the control equations for different physical parameters in the model are respectively:

### Mass:

$$\frac{\partial \overline{ρ}}{\partial t} + \frac{\partial \overline{ρ} {\overline{u}}_{j}}{\partial {x}_{j}} = 0 ;$$

### Momentum:

$$\frac{\partial \overline{ρ} {\overline{u}}_{j}}{\partial t} + \frac{\partial ρ {\overline{u}}_{i} {\overline{u}}_{j}}{\partial {x}_{j}} = \frac{\partial }{\partial {x}_{j}} ( ρ ( v + {v}_{t} ) ( \frac{\partial {\overline{u}}_{i}}{\partial {x}_{j}} + \frac{\partial {\overline{u}}_{j}}{\partial {x}_{i}} - \frac{2}{3} \frac{\partial {\overline{u}}_{k}}{\partial {x}_{k}} {δ}_{ij} ) ) - \frac{\partial {\overline{p}}_{d}}{\partial {x}_{i}} - {g}_{i} {x}_{i} \frac{\partial \overline{p}}{\partial {x}_{i}} ;$$

### Energy:

$$\frac{\partial \overline{ρ} \overline{h}}{\partial t} + \frac{\partial \overline{ρ} {\overline{u}}_{j} \overline{h}}{\partial {x}_{j}} = \frac{D \overline{p}}{Dt} + \frac{\partial }{\partial {x}_{j}} [ \overline{ρ} ( D + \frac{{v}_{t}}{{Pr}_{t}} ) \frac{\partial \overline{h}}{\partial {x}_{j}} ] ;$$

### Component:

$$\frac{\partial \overline{ρ} {\overline{Y}}_{m}}{\partial t} + \frac{\partial \overline{ρ} {\overline{u}}_{j} {\overline{Y}}_{m}}{\partial {x}_{j}} = \frac{\partial }{\partial {x}_{j}} [ \overline{ρ} ( D + \frac{{v}_{t}}{{Pr}_{t}} ) \frac{\partial {\overline{Y}}_{m}}{\partial {x}_{j}} ] ;$$

### Turbulent Kinetic Energy:

$$\frac{\partial k}{\partial t} + {\overline{u}}_{j} \frac{\partial k}{\partial {x}_{j}} = \frac{\partial }{\partial {x}_{j}} [ \frac{( v + {v}_{t} )}{{σ}_{k}} \frac{\partial k}{\partial {x}_{j}} ] - ε + {τ}_{ij} \frac{\partial {\overline{u}}_{i}}{\partial {x}_{j}} ;$$

### Dissipation Rating:

$$\frac{\partial ε}{\partial t} + {\overline{u}}_{j} \frac{\partial ε}{\partial {x}_{j}} = \frac{\partial }{\partial {x}_{j}} [ \frac{( v + {v}_{t} )}{{σ}_{k}} \frac{\partial ε}{\partial {x}_{j}} ] + {C}_{ε 1} \frac{ε}{k} {τ}_{ij} \frac{\partial {\overline{u}}_{i}}{\partial {x}_{j}} - {C}_{ε 2} \frac{{ε}^{2}}{k} .$$

Further, in the above technical solution, the step of calculating the heat generated inside a battery during thermal runaway specifically includes:
solving the combustion behavior inside the battery energy storage system by the eddy dissipation concept (EDC) model, wherein the combustion rate of each gas component is considered to be a function of the fluid temperature and the reaction gas concentration, expressed as:

$$ω = A \cdot {{{exp ( - Ea / RT ) [ Fuel ]}^{a} [ {O}_{2} ]}^{b} [ {H}_{2} O ]}^{c} ;$$

where, [Fuel], [O₂] and [H₂O] respectively represent the proportions of fuel, oxygen and water in a grid; and, a, b and c are the reaction orders.

Further, in the above technical solution, the step of solving a conservation equation of a fluid region in the battery energy storage system, to predict the fire spread behavior inside the energy storage power station, specifically includes:
with the battery temperatures and the jet dynamics parameters of the batteries as the boundary conditions, the heat generation inside the batteries during the thermal runaway and the gas generation inside the batteries during the thermal runaway are introduced into OpenFOAM for coupling to solve the conservation equation of the fluid region in the battery energy storage system, thereby predicting the fire spread behavior inside the energy storage power station.

Specifically, the principle of the present disclosure is as follows: obtaining battery electrochemical parameters, material thermophysical parameters and energy storage system geometric characteristic parameters of a battery energy storage system; establishing a three-dimensional geometric model of air domain inside the energy storage system and performing a grid division, according to the battery electrochemical parameters, the material thermophysical parameters and the energy storage system geometric characteristic parameters; establishing a thermal runaway model of a single battery node in the battery energy storage system, to calculate the heat generated inside the battery during thermal runaway; establishing a thermal resistance network model of a battery region in the battery energy storage system, to solve the heat transfer and thermal runaway propagation process between batteries, and calculate the battery temperatures; establishing a gas generation model of a single battery node in the battery energy storage system, to calculate the gas generation inside the battery during thermal runaway; establishing a mass flow model of a battery region in the battery energy storage system, to solve jet dynamics parameters of the battery; and, solving a conservation equation of a fluid region in the battery energy storage system, with the battery temperatures and the jet dynamics parameters of the batteries as boundary conditions, to predict the fire spread behavior inside an energy storage power station.

### EMBODIMENTS

Taking a 3.5 MWh walk-in energy storage power station as an example, the thermal runaway propagation and the flame propagation behavior after a thermal runaway accident occurred in the power station are simulated to describe the present disclosure comprehensively and in detail, but the protection scope of the present disclosure is not limited to the following specific embodiments. The energy storage unit of the energy storage power station is a 120 Ah lithium iron phosphate-graphite square lithium-ion battery, and the container contains a total of 240 battery modules and 7,200 battery cells. The method is mainly divided into the following three parts: (1) obtaining parameters and establishing geometric models; (2) solving the thermal resistance network model and the mass flow model, to calculate the battery temperature evolution during thermal runaway propagation; and (3) solving computational fluid mechanics model to calculate the temperature distribution and heat release characteristics during flame propagation.

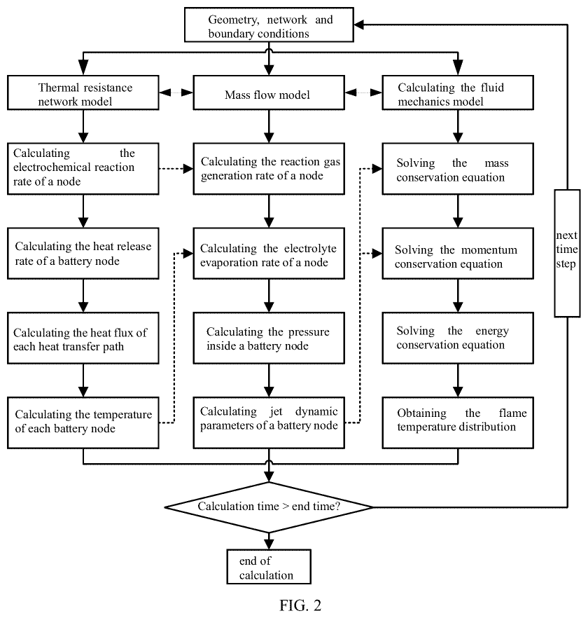

(1) First, the Part of Obtaining Parameters and Establishing Geometric Models is Described, which is Divided into Two Steps, as Follows:
Step 1: obtaining parameters. The physical parameters and reaction dynamics parameters of the battery are obtained according to the literature research method.
Step 2: establishing the geometric model. According to the actual situation of the battery specifications and arrangement in the energy storage container, a geometric model is established and a grid division is performed. The model geometry is shown in FIG. 2, and its modeling region is the flow field region outside the battery cluster. The boundaries of the calculation model include the ground, the surfaces of the battery cluster, vents of the battery module, the walls of the energy storage container and the outlets of the container.

### (2) the Thermal Resistance Network Model and the Mass Flow Model are Solved to Calculate the Battery Temperature Evolution During Thermal Runaway Propagation:

According to the initial parameters and the equations, the thermal runaway model of a single battery node is established to calculate the heat generation inside the battery during thermal runaway and calculate the gas generation rate and jet dynamics parameters inside the battery; the thermal resistance network model and the mass flow model of the battery region are established, to solve the heat transfer flux between adjacent battery nodes, thereby calculating the temperatures of the battery nodes according to the energy balance.

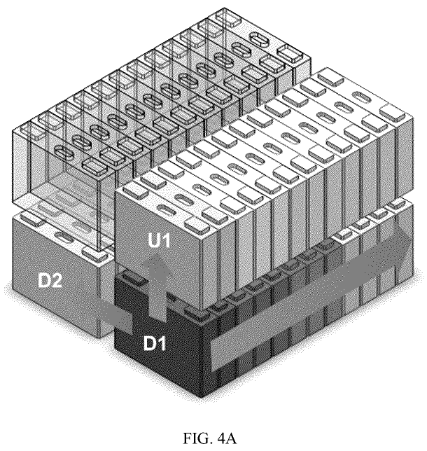

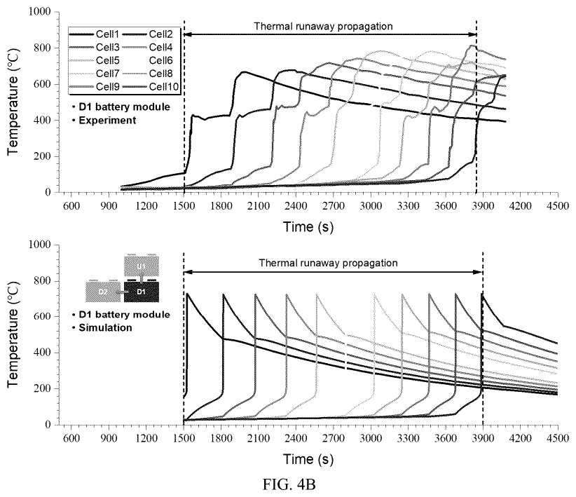

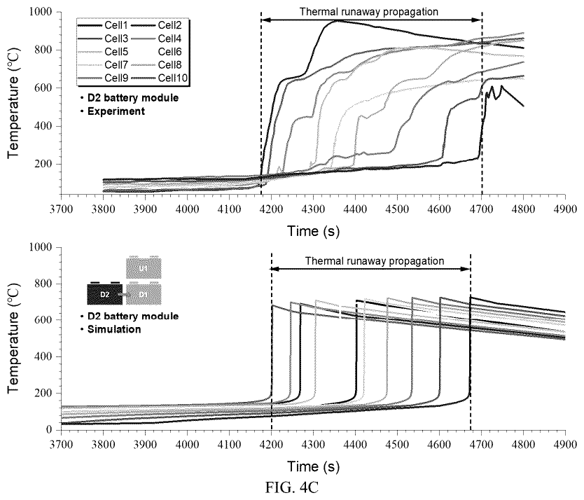

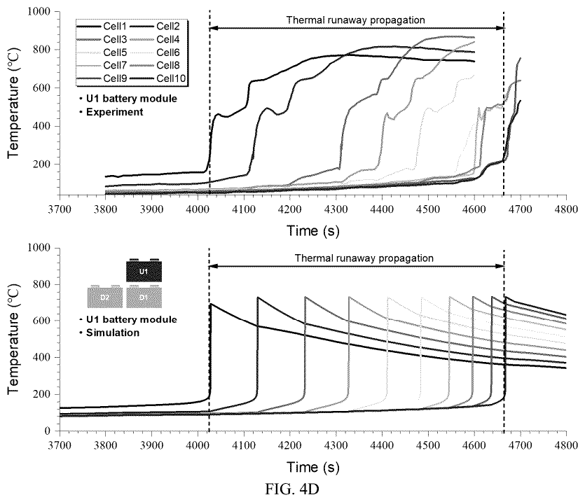

As shown in FIG. 4A, FIG. 4B, FIG. 4C, and FIG. 4D, the temperature evolution of each battery cell inside the battery modules during the thermal runaway is shown, and is compared with the experimental results (Ditch B, Zeng D. Fire Hazard of Lithium-ion Battery Energy Storage Systems: 1. Module to Rack-scale Fire Tests. Fire Technology. 2020.). In this embodiment, the battery modules at three characteristic positions are selected, which are respectively: the module (D1) initially triggered by thermal runaway, the module (D2) on its left side, and the module (U1) above it, as shown in the FIG. 4A. FIG. 4B shows the temperature evolution curve of each battery in the D1 module, and it can be seen from the figure that the thermal runaway propagation time obtained by simulation and the thermal runaway trigger time of each battery are highly consistent with the experimental results. The experimentally measured thermal runaway propagation duration is about 2343 s, and the thermal runaway duration calculated by simulation is about 2402 s, from which it can be found that the prediction error is 2.45% and is in an acceptable range. Meanwhile, the simulations also nicely captured the acceleration process of thermal runaway propagation, a phenomenon caused by the injection and combustion of the high-temperature gases at the top of the battery modules. As shown in FIG. 4D, the module U1 also enters the thermal runaway stage at 4021s, and has a shorter propagation duration due to the preheating of the bottom module. It can be found that the overall temperature evolution characteristics and propagation duration obtained by experiment are similar to those obtained by simulation. As shown in FIG. 4C, the thermal runaway in the module D2 is triggered at 4174 s. In experiments, the entire propagation process lasts for about 527 s, while the corresponding predicted duration is 476 s, with a relative error of 9.6%. The above results have proved the accuracy of the modeling method proposed in the present disclosure in predicting the thermal runaway propagation characteristics.

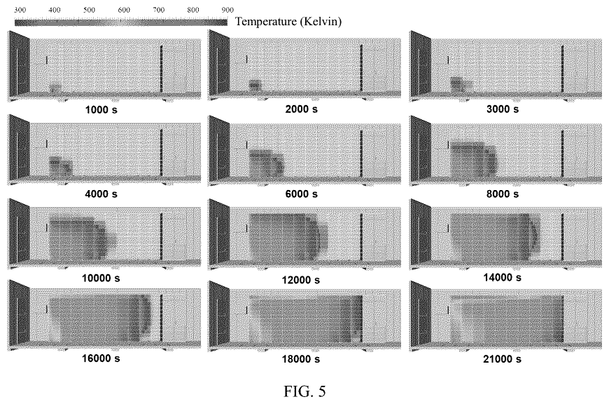

As shown in FIG. 5, the thermal runaway propagation characteristics of thermal runway between modules are shown. It can be found that the model calculation results well capture the propagation process of thermal runaway throughout the entire battery cluster. At the same time, due to the upward spread of the flame under the effect of buoyancy, it can be observed that the upward propagation speed of thermal runaway is greater than its vertical propagation speed, which is consistent with the previous experimental results, thereby proving that the models can capture the interaction between thermal runaway and flame.

### (3) Computational Fluid Mechanics Models are Solved to Calculate the Temperature Distribution and Heat Release Characteristics During Flame Propagation.

The battery node temperatures obtained from the thermal resistance network calculation and the jet dynamics parameters obtained from the mass flow models will be used as dynamic boundary conditions to participate in the calculation of the computational fluid mechanics models to simulate the fire spread process.

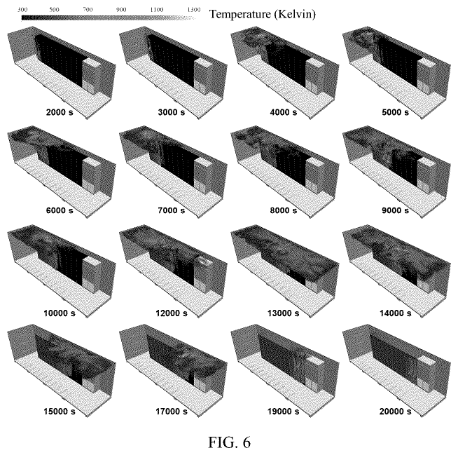

As shown in FIG. 6, the lithium-ion battery fire evolution process obtained by simulation is shown. It can be found that in the early stage of a fire, flame will quickly spread upwardly after the battery pack releases the gas, accelerating the thermal runaway propagation process. As the fire and thermal runaway progress, the fire intensity and flame height steadily increase, forming a ceiling jet. In the later stage of fire spread, the number of burning batteries gradually decreases, and the fire intensity also gradually decreases.

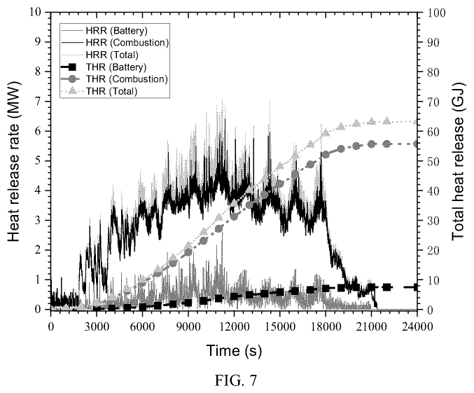

As shown in FIG. 7, the heat release rate curves and the total heat release curves during the fire spread evolution of lithium-ion batteries are shown. It can be found that the heat release rate curves of combustion fluctuate continuously with the thermal runaway propagation, and generally present a trend of first increasing and then decreasing. In addition, the models proposed in the present disclosure can also be used to calculate the total heat released by combustion and thermal runaway.

What is described above is only specific embodiments of the present disclosure, but the protection scope of the present disclosure is not limited thereto. Within the technical scope disclosed in the present disclosure, anyone skilled in the art can easily think of changes or substitutions which should be covered within the protection scope of the present disclosure. Therefore, the protection scope of the present disclosure should be based on the protection scope of the claims.

1. A coupling network model lithium-ion battery energy storage system fire spread modeling method, comprising:
obtaining battery electrochemical parameters, material thermophysical parameters and energy storage system geometric characteristic parameters of a battery energy storage system;
establishing a three-dimensional geometric model of air domain inside the battery energy storage system and performing a grid division, according to the battery electrochemical parameters, the material thermophysical parameters and the energy storage system geometric characteristic parameters;
establishing a thermal runaway model of a single battery node in the battery energy storage system, to calculate heat generation inside batteries during thermal runaway;
establishing a thermal resistance network model of a battery region in the battery energy storage system, to solve a heat transfer and a thermal runaway propagation process between batteries, and calculate battery temperatures;
establishing a gas generation model of a single battery node in the battery energy storage system, to calculate the gas generation inside batteries during thermal runaway;
establishing a mass flow model of a battery region in the battery energy storage system, to solve jet dynamics parameters of batteries;
transmitting the calculated heat generation, the calculated battery temperatures, the calculated gas generation and the jet dynamics parameters of batteries to a device to perform a prediction of a fire spread behavior inside an energy storage power station; and
displaying, via the device, the fire spread behavior inside the energy storage power station;
wherein the step of establishing a thermal resistance network model of a battery region in the battery energy storage system comprises:
based on a consideration of a heat conduction between batteries, a heat convection between a battery and a top fluid of a battery package, and a heat exchange between a battery and a surrounding environment, determining an energy balance of a single battery node in the thermal resistance network as:
$${m}_{c} {C}_{p , c} \frac{{dT}_{c , x , y , z}}{dt} = {Q}_{TR} + {\sum }_{j = x - 1 , x + 1} \frac{{T}_{c , i , y , z} - {T}_{c , x , y , z}}{{R}_{κ , x}} + {\sum }_{j = y - 1 , y + 1} \frac{{T}_{c , x , j , z} - {T}_{c , x , y , z}}{{R}_{κ , y}} + ( \frac{{T}_{v , xm , z - 1} - {T}_{c , x , y , z}}{{R}_{h , u}} + \frac{{T}_{v , xm , z} - {T}_{c , x , y , z}}{{R}_{h , l} + {R}_{s}} ) ;$$
where, c represents a battery, v represents the top fluid of the battery package, x, y and z represent position coordinates of a battery in a battery cluster, T_{c,x,y,z} represents a temperature of a battery at the x,y,z coordinate; R_{k,x} represents a thermal conduction resistance between batteries along the x direction, and R_{k,y} represents a thermal conduction resistance between batteries along the y direction; R_{h,u} represents a thermal convection resistance at top of a battery module, and R_{h,l} represents a thermal convection resistance at bottom of the battery module; and, R_{S} represents a thermal resistance of a battery pack casing;
determining a fluid region at the top of the battery module as a separate node, wherein in an entire thermal runaway propagation process, batteries continue to exchange heat with the top fluid at high-temperature through convective heat exchange, a high-temperature gas and flame injected by batteries increase a temperature of the top fluid, so an energy conservation equation of a fluid node at the top of the battery module is determined as:
$${m}_{v} {C}_{p , v} \frac{{dT}_{v , xm , z}}{dt} - {\sum }_{i ∈ {M}_{xm}} {\sum }_{j = 1}^{{n}_{y}} {\dot{m}}_{c , i , j , z} {C}_{p , v} {T}_{f} + {\dot{m}}_{v , xm , z} {C}_{p , v} {T}_{v , xm , z} = {\sum }_{i ∈ {M}_{xm}} {\sum }_{j = 1}^{{n}_{y}} \frac{{T}_{c , i , j , z} - {T}_{v , xm , z}}{{R}_{h , u}} + {\sum }_{i ∈ {M}_{xm}} {\sum }_{j = 1}^{{n}_{y}} \frac{{T}_{c , i , j , z + 1} - {T}_{v , xm , z}}{{R}_{h , l} + {R}_{s}} ;$$
where, xm represents a position coordinate of the battery package inside the energy storage power station, \dot{m}c represents a mass flow rate when exhaust occurs in the battery, and T_{f} represents a temperature of discharged gas; and
obtaining a temperature evolution of each battery node by coupling solution of above equations, to calculate a fluid mechanics model.

2. The coupling network model lithium-ion battery energy storage system fire spread modeling method according to claim 1, wherein the step of establishing a thermal runaway model of a single battery node in the battery energy storage system specifically comprises:
step 1, a umped transient energy conservation equation based on an Arrhenius formula, describing a process in which the battery temperature continues to rise due to the heat released by an electrochemical reaction during thermal runaway;
$${m}_{c} {C}_{p , c} \frac{dT}{dt} = {Q}_{TR} + \sum \frac{{T}_{neigh} - T}{R} ; \\ {Q}_{TR} = - {\sum }_{i} Δ {H}_{i} \frac{{dc}_{i}}{dt} ;$$
where, m_{c} is a mass of a battery, ρ is a density, C_{p,c} is a specific heat capacity of a battery, T is a node temperature, T_{neigh} is a temperature of an adjacent node, t is time, Q_{TR} is heat released by a side reaction in a thermal runaway process, ΔHᵢ is an enthalpy value of a thermal abuse reaction, cᵢ is a dimensionless concentration of an active material, dcᵢ/dₜ can be solved by using the Arrhenius formula, and R is a constant; and
step 2, determining a control equation of the thermal runaway model, which specifically comprises:
SEI film decomposition:
$$\frac{{dc}_{SEI}}{dt} = - {A}_{SEI} {c}_{SEI} exp ( - \frac{{Ea}_{SEI}}{RT} ) ;$$
where, c_{SEI} represents a dimensionless concentration of SEI film, A_{SEI} and Eα_{SEI} represent a pre-exponential factor and an activation energy of SEI film decomposition, and R represents a gas constant;
negative electrode reaction:
$$\frac{{dc}_{a}}{dt} = - {A}_{a} {c}_{a} exp ( - \frac{{Ea}_{a}}{RT} ) exp ( - \frac{{c}_{SEI}}{{c}_{SEI , ref}} ) ;$$
where, α represents a negative electrode, c_{α} represents the dimensionless concentration of a negative electrode active material, A_{α} and Eα_{α} represent the pre-exponential factor and the activation energy of a negative electrode reaction, and C_{SEI,ref} represents a reference dimensionless concentration of a SEI film;
positive electrode reaction:
$$\frac{d {α}_{c}}{dt} = {A}_{c} {α}_{c} ( 1 - {α}_{c} ) exp ( - \frac{{Ea}_{c}}{RT} ) ;$$
where, c represents a positive electrode, α_{c} represents a conversion fraction of a positive electrode material, and, A_{c} and Eα_{c} represent the pre-exponential factor and the activation energy of a positive electrode reaction;
electrolyte decomposition:
$$\frac{{dc}_{e}}{dt} = - {A}_{e} {c}_{e} exp ( - \frac{{Ea}_{e}}{RT} ) ;$$
where, e represents an electrolyte, cₑ represents the dimensionless concentration of the electrolyte, Aₑ and Eαₑ represent the pre-exponential factor and the activation energy of the electrolyte decomposition;
binder reaction:
$$\frac{{dc}_{PVDF}}{dt} = - {A}_{PVDF} {c}_{PVDF} exp ( - \frac{{Ea}_{PVDF}}{RT} ) ;$$
where, PVDF represents a binder, C_{PVDF} represents the dimensionless concentration of the binder, A_{PVDF} and Eα_{PVDF} represent the pre-exponential factor and the activation energy of the electrolyte decomposition.

3. (canceled)

4. The coupling network model lithium-ion battery energy storage system fire spread modeling method according to claim 2, wherein the step of establishing a gas generation model of a single battery node in the battery energy storage system comprises:
a gas generation process inside a lithium-ion battery comprising electrolyte evaporation and side reaction release, wherein an evaporation rate in the electrolyte evaporation process is:
$${\dot{n}}_{e} = {α}_{l} {l}_{1} {l}_{2} \frac{2 C}{2 - C} \sqrt{\frac{{M}_{e}}{2 π R}} \frac{{ρ}_{v} {Δ}_{vap} H ( T - {T}_{sat} )}{{T}_{sat}^{3 / 2} {M}_{e}} ;$$
where, αₗ is a volume fraction of the electrolyte in a coil core, l₁ and l₂ are geometric parameters of a battery, C is an evaporation coefficient; Mₑ is a molar mass of the electrolyte, ρᵥ is a vapor density inside a battery, ΔᵥₐₚH is an enthalpy of evaporation, and Tₛₐₜ is a saturation temperature of the electrolyte, expressed as:
$${T}_{sat} = \frac{1413}{64338 - log ( P / 1000 )} + 44 \text{.25} ;$$
where, P represents a pressure inside a battery.

5. The coupling network model lithium-ion battery energy storage system fire spread modeling method according to claim 4, wherein for a reaction gases, hydrogen, carbon monoxide, carbon dioxide, methane, ethylene and ethane are mainly considered, and their generation rates are considered to be a linear function of an electrochemical reaction rate,
$${\dot{n}}_{g} = \sum {ω}_{i} \frac{{dc}_{i}}{dt} ;$$
where, ωᵢ is a gas generation coefficient, obtained from an experimentally measured total amount of gas generation.

6. The coupling network model lithium-ion battery energy storage system fire spread modeling method according to claim 5, wherein the step of establishing a mass flow model of a battery region in the battery energy storage system specifically comprises: an internal pressure and a jet dynamics model of a fluid node in the battery module are calculated by using ordinary differential equations, where, a control equation representing a pressure change is expressed as:
$$\frac{{dn}_{v , xm , z}}{dt} = {\sum }_{i ∈ {M}_{xm}} {\sum }_{j = 1}^{{n}_{y}} ( {\dot{n}}_{e , i . j , z} + {\dot{n}}_{g , i . j , z} ) - \frac{φ {C}_{d} {A}_{v} {ρ}_{v , xm , z} {u}_{v , xm , z}}{{M}_{v , xm , z}} ;$$
where, Σ_{i∈M}_{ₓₘ}Eⱼ₌₁ⁿ^{_{y}}(\dot{n}_{e,i,j,z}+\dot{n}_{g,i,j,z}) represents a molar flow rate when exhaust occurs in the battery, and
$$\frac{φ {C}_{d} {A}_{v} {ρ}_{v , xm , z} {u}_{v , xm , z}}{{M}_{v , xm , z}}$$
represents a gas loss due to an exhaust of the battery package; where, φ is a blockage coefficient, C_{d} is an exhaust coefficient, Aᵥ is an area of an exhaust valve of the battery package, ρ is a gas density, and u is a gas jet velocity.

7. The coupling network model lithium-ion battery energy storage system fire spread modeling method according to claim 6, wherein the gas jet velocity is calculated from a internal pressure of a battery, expressed as:
$${P}_{v} = max ( {P}_{a} , {( \frac{2}{γ + 1} )}^{γ / ( γ - 1 )} P ) ;$$
$$Ma = min ( 1 , \sqrt{( {( \frac{P}{{P}_{v}} )}^{( γ - 1 ) / γ} - 1 ) \frac{2}{γ - 1}} ) ;$$
$$u = Ma \sqrt{\frac{γ {P}_{v}}{ρ}} ;$$
where, γ represents a heat capacity ratio of a discharged gas mixture, Pᵥ is the pressure at the exhaust valve of the battery package, and P_{α} is a environmental pressure; Mα is a Mach number.

8. (canceled)

9. (canceled)

10. (canceled)
